(19) United States
(12) Patent Application Publication
(10) Pub. No.: US 2020/0367159 A1
(43) Pub. Date: Nov. 19, 2020

(54) Device Resource Savings During Cellular Out-of-Service Condition

(71) Applicant: Motorola Mobility LLC, Chicago, IL (US)

(72) Inventors: Kishor Kolli, Bangalore (IN); Jilji Narayanan Elayath, Bangalore (IN); Dipti Dipak Fulzele, Bangalore (IN); Pradeep Seshadri, Bangalore (IN); Satheesh Thotasagara Vishakantappa, Bengaluru (IN); Rajesh Kumar Subramanian, Bangalore (IN)

(73) Assignee: Motorola Mobility LLC, Chicago, IL (US)

(21) Appl. No.: 16/413,530

(22) Filed: May 15, 2019

(51) Int. Cl. H04W 52/02; H04W 68/02; H04W 72/04; H04W 48/16

(52) U.S. Cl. CPC H04W 52/0216; H04W 48/16; H04W 72/048; H04W 68/02

(57) ABSTRACT

In aspects of device resource savings during cellular out-of-service condition, a device includes a cellular radio for cellular network communication via a cellular network. The device implements a communication manager that detects an out-of-service condition for lack of a cellular network connection with the device. The communication manager can communicate a notification to collaborative devices that the device is a master device implemented to scan for the cellular network during the out-of-service condition, and the notification serves to initiate the collaborative devices saving resources by switching-off respective cellular radios. The communication manager can initiate scans to detect the cellular network and establish the cellular network connection with the cellular network, and then communicate scan data associated with detection of the cellular network to the collaborative devices that use the scan data to establish respective cellular network connections with the cellular network.

### BACKGROUND

Devices such as smart devices, Internet of Things (IoT) devices, wireless access points, mobile devices (e.g., cellular phones, tablet devices), consumer electronics, and the like can be implemented for use in a wide range of industries and may use various networking technologies and protocols to communicate with other devices, servers, and/or cloud systems. Any number of these devices may be implemented for cellular network communication via a cellular network, using any of the various cellular wireless technology generations (e.g., any of 2G, 3G, 4G, and 5G).

Additionally, any number of the devices may be implemented for cellular network communication, and may also be integrated, synchronized, and/or communicatively linked with one another. For example, a mobile device, such as a cellular mobile phone, may include a modular component integrated with the mobile device. Similarly, an IoT device may be communicatively linked with the mobile device, and/or a wearable device may be synchronized and communicatively linked with the mobile device. During a cellular out-of-service condition, it is likely that all of the proximate devices will experience the same out-of-service condition. The devices that are implemented for cellular network communication will then each use battery power to independently perform scanning for the cellular network on all of the possible cellular wireless technology generations (e.g., any of 2G, 3G, 4G, and 5G) to determine a suitable cellular network so as to establish, or re-establish, a cellular network connection.

### BRIEF DESCRIPTION OF THE DRAWINGS

Implementations of device resource savings during cellular out-of-service condition are described with reference to the following Figures. The same numbers may be used throughout to reference like features and components shown in the Figures:

FIG. 1 illustrates an example system with devices that can be used to implement techniques of device resource savings during cellular out-of-service condition as described herein.

FIG. 2 illustrates an example method of device resource savings during cellular out-of-service condition as implemented in a master device.

FIG. 3 illustrates an example method of device resource savings during cellular out-of-service condition as implemented by a master device and scanning distributed across multiple collaborative devices.

FIG. 4 illustrates an example method of device resource savings during cellular out-of-service condition as implemented in a collaborative device.

FIG. 5 illustrates an example method of device resource savings during cellular out-of-service condition in accordance with one or more implementations of the techniques described herein.

FIG. 6 illustrates various components of an example device that can implement aspects of device resource savings during cellular out-of-service condition.

### DETAILED DESCRIPTION

Implementations of device resource savings during cellular out-of-service condition are described, and provide techniques to conserve device resources. Notably, devices that may be integrated, synchronized, and/or communicatively linked may also each implement various radio access technologies for network communications, such as via Bluetooth™, Wi-Fi, and the generations of cellular wireless technologies (e.g., 2G, 3G, 4G, and 5G). For example, a mobile device, such as a mobile phone or smart phone, includes a cellular radio system for cellular network connection to a cellular network via any one of the cellular wireless technologies. Similarly, collaborative devices, such as a modular component integrated with the mobile device, an Internet of Things (IoT) device that is communicatively linked with the mobile device, and/or a wearable device that is synchronized and communicatively linked with the mobile device, may also include a cellular radio system for cellular network connection to the cellular network via any one of the cellular wireless technologies.

In implementations, a mobile device may include a modular component, either as an integrated component of the mobile device or as an attachment that operates with the mobile device. The modular component can add an additional communication technology (e.g., cellular 5G) to the mobile device, or provide additional performance, entertainment, gaming, and/or audio and visual enhancements as integrated modular components of the mobile device. An IoT device, such as a camera device or other type of the many mobile or fixed IoT devices may be communicatively linked with the mobile device. Similarly, a wearable device that is generally designed to be worn by, attached to, carried by, or otherwise transported by a user may be synchronized and communicatively linked with the mobile device. As described herein, a collaborative device of the mobile device is generally any type of computing and/or electronic device that is integrated, synchronized, and/or communicatively linked to the mobile device, such as a modular component, an IoT device, a wearable device, or many other various, different examples of a collaborative device.

Notably, these devices can each be implemented for cellular network connection to a cellular network. Generally, if one device (e.g., the mobile device) experiences an out-of-service condition for lack of a cellular network connection, then it is very likely that proximate devices (e.g., the collaborative devices) will also experience the same out-of-service condition. In aspects of device resource savings during cellular out-of-service condition as described herein, the devices can collaborate with each other during the cellular out-of-service condition to initiate scanning for the cellular network, and to establish, or re-establish, the cellular network connection. The collaborative techniques implemented by the devices provide for device resource savings during the out-of-service condition in the form of conserving device battery power and/or saving time by being able to quickly re-establish network connectivity.

In aspects described herein, the mobile device implements a communication manager that detects an out-of-service condition for lack of a cellular network connection by the cellular radio system of the device. The communication manager can also establish the mobile device as a master device over the collaborative devices, such as the modular component of the mobile device, the IoT device, and/or the wearable device that are integrated, synchronized, and/or communicatively linked to the mobile device. Notably, the master device status can be established based on the mobile device having more available battery power than the collaborative devices. For example, a mobile phone may have more available battery power for cellular network scanning than a smaller wearable device or IoT device that is communicatively linked with the mobile phone. Alternatively or in addition, the master device status of the mobile device may be established based on a pre-defined hierarchy of the mobile device in relation to the collaborative devices.

The communication manager of the mobile device can detect the out-of-service condition for the lack of the cellular network connection and notify the collaborative devices of the master device status by way of a master device notification that is communicated to the collaborative devices. This is effective to initiate the collaborative devices saving resources by switching-off their respective cellular radio systems, thus saving battery power of the collaborative devices that would otherwise be utilized to scan for the cellular network during the out-of-service condition.

Similar to the mobile device, the collaborative device may also implement a communication manager that implements features of device resource savings during cellular out-of-service condition, as described herein. The communication manager in a collaborative device can also detect the out-of-service condition for lack of the cellular network connection by the cellular radio system in a respective device. The communication manager of a collaborative device can receive the master device notification from the mobile device, which indicates that the master device (e.g., the mobile device) will perform the scanning for the cellular network during the out-of-service condition. The communication manager of the collaborative device can then initiate to switch-off the cellular radio system of the respective collaborative device for the resource savings during the out-of-service condition.

As an alternative to the communication manager of the collaborative device first receiving the master device notification from the mobile device and then initiating to switch-off the cellular radio system of the collaborative device, the communication manager of the collaborative device may detect the out-of-service condition and initiate to switch-off the cellular radio system to conserve device battery power. Given that the master device status of the mobile device may be established based on a pre-defined hierarchy of the mobile device in relation to the collaborative devices, the communication manager of the collaborative device may not wait to receive the master device notification before initiating to switch-off the cellular radio system of the collaborative device during the out-of-service condition, thus saving device battery power.

As the designated or pre-defined master device, the cellular radio system of the mobile device can perform the network scanning for all of the devices to detect the cellular network during the out-of-service condition, and once determined, can establish the cellular network connection with the cellular network. The communication manager of the mobile device can then communicate scan data associated with detection of the cellular network to the collaborative devices. The communication manager of a collaborative device can then initiate to switch-on the respective cellular radio system, which then uses the scan data as received from the master device to establish, or re-establish, a cellular network connection with the cellular network.

In alternate aspects of resource savings during cellular out-of-service condition, the communication manager of the mobile device can detect the out-of-service condition for lack of the cellular network connection by the cellular radio system of the device, and establish the mobile device as the master device, as described above. The communication manager of the master device can then designate different cellular wireless technology generations for the mobile device to scan and for one or more of the collaborative devices to scan. For example, the communication manager of the master device can designate a first cellular wireless technology generation (e.g., any of 2G, 3G, 4G, and 5G) for the mobile device to scan for the cellular network, and also designate a second, different cellular wireless technology generation for a collaborative device to scan for the cellular network. This technique can be effective to determine and connect to a suitable cellular network faster than if just one of the devices is scanning for the cellular network, and can be used to quickly re-establish network connectivity. This is a resource savings during the out-of-service condition in the form of time, and can decrease the duration of time that the devices may be out-of-service.

While features and concepts of device resource savings during cellular out-of-service condition can be implemented in any number of different devices, systems, networks, environments, and/or configurations, implementations of device resource savings during cellular out-of-service condition are described in the context of the following example devices, systems, and methods.

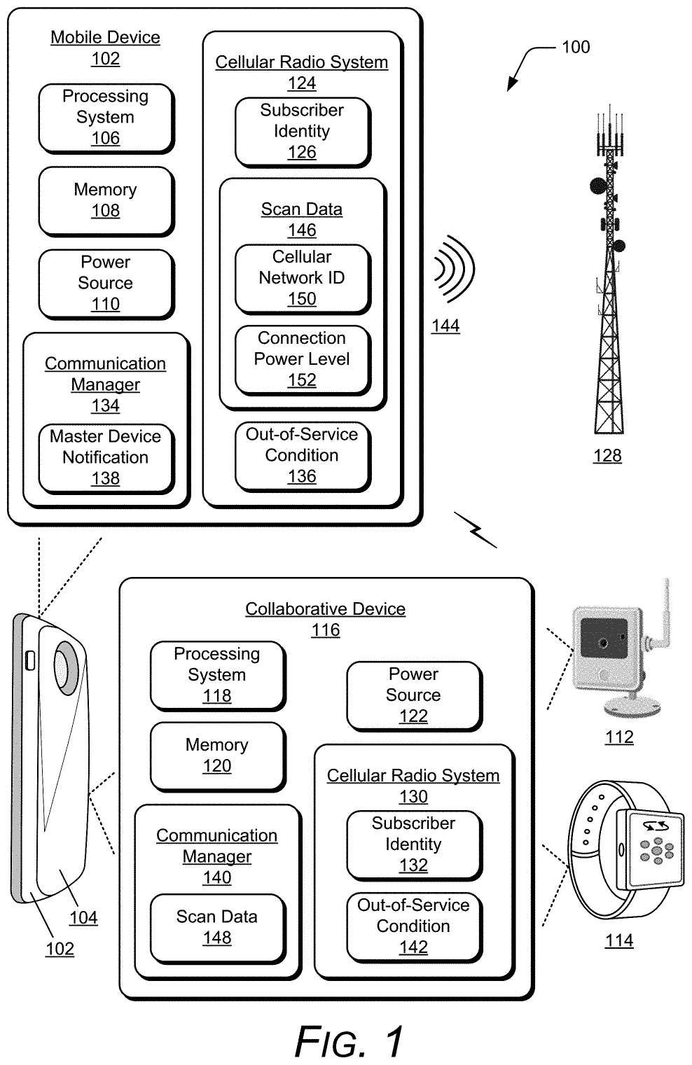

FIG. 1 illustrates an example of a system 100 with devices that can be used to implement techniques of device resource savings during cellular out-of-service condition, as described herein. In this example, the system 100 includes a mobile device 102, such as a mobile phone, smart phone, tablet device, and the like. The mobile device 102 may also include a modular component 104, either as an integrated component of the mobile device 102 or as an attachment that operates with the mobile device. In implementations, the modular component 104 may add an additional communication technology (e.g., cellular 5G) to the mobile device 102, or provide additional performance, entertainment, gaming, and/or audio and visual enhancements as integrated modular components of the mobile device.

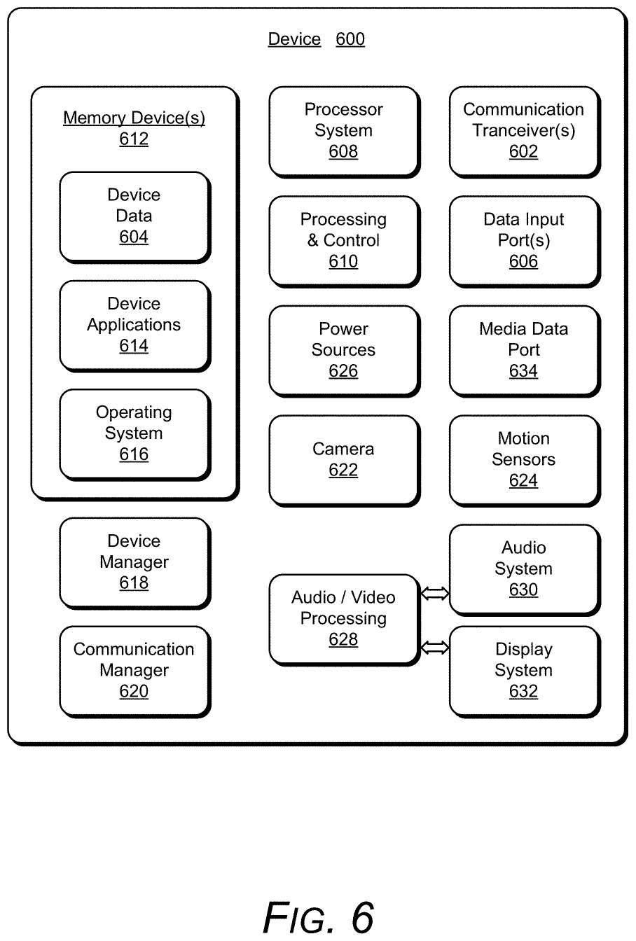

Generally, the mobile device 102 is any type of an electronic and/or computing device implemented with various components, such as a processing system 106 and memory 108, as well as any number and combination of different components as further described with reference to the example device shown in FIG. 6. For example, the mobile device 102 can include a power source 110 to power the device, such as a rechargeable battery and/or any other type of active or passive power source that may be implemented in an electronic and/or computing device.

The example system 100 also includes an Internet of Things (IoT) device 112, such as a camera device or other type of the many mobile or fixed IoT devices that may be communicatively linked with the mobile device 102. The example system 100 also includes a wearable device 114 that may be synchronized and communicatively linked with the mobile device 102. A wearable device is generally designed to be worn by, attached to, carried by, or otherwise transported by a user, such as any type of glasses, a smart band or watch, media playback device, fitness device, and the like. The modular component 104 of the mobile device 102, the IoT device 112, and the wearable device 114 are all various, different examples of a collaborative device 116 included as part of the example system 100. Generally, a collaborative device of the mobile device 102 is any type of computing and/or electronic device that is integrated, synchronized, and/or communicatively linked to the mobile device.

The collaborative device 116 is representative of any type of a computing device, mobile device (e.g., mobile phone or tablet), IoT device, wireless device, access point, node device, and/or electronic device implemented for cellular network and/or wireless communication. Similar to the mobile device 102, the collaborative device 116 can be implemented with various components, such as a processing system 118 and memory 120, as well as any number and combination of different components as further described with reference to the example device shown in FIG. 6.

In this example, the mobile device 102 includes a cellular radio system 124 with a subscriber identity 126, which may be implemented as a subscriber identity module (SIM or commonly referred to as a SIM card) or as an embedded SIM (eSIM) designed to securely store the international mobile subscriber identity (IMSI) number and related security key for the mobile device, and which are used to identify and authenticate the device as a subscriber on a cellular network 128. A cell tower is representative of the overall cellular network 128 in this example system. Generally, the mobile device 102 implements the cellular radio system 124 with a radio device, antenna, and chipset implemented for cellular network communication with other devices, networks, and services utilizing any suitable communication protocol or standard, such as any one or more of the 2G, 3G, 4G, and 5G generations of cellular wireless technologies.

Similarly, the collaborative device 116 includes a cellular radio system 130 with a subscriber identity 132, which may also be implemented as a SIM card or as an eSIM designed to securely store the IMSI number and related security key for the collaborative device, and which are used to identify and authenticate the device as a subscriber on the cellular network 128. As with the mobile device 102, the collaborative device 116 generally implements the cellular radio system 130 with a radio device, antenna, and chipset implemented for cellular network communication with other devices, networks, and services utilizing any suitable communication protocol or standard, such as any one or more of the 2G, 3G, 4G, and 5G generations of cellular wireless technologies.

The various devices can also communicate with each other via a network (e.g., WLAN) or via a direct peer-to-peer connection (e.g., Wi-Fi Direct, Bluetooth™, Bluetooth LE (BLE), RFID, etc.). Although not shown, the mobile device 102 and/or a collaborative device 116 can include communication interfaces that facilitate network communications, as well as additional wireless radios that facilitate wireless communications, such as for Mobile Broadband, LTE, Near Field Communication (NFC), Real-time Locating System (RTLS), or any other wireless radio system or format for communication via respective wireless networks. The mobile device 102 and the collaborative device 116 can be implemented for data communication between devices and network systems, which may include wired and/or wireless networks implemented using any type of network topology and/or communication protocol, to include IP based networks, and/or the Internet, as well as networks that are managed by mobile network operators, such as a communication service providers, mobile phone providers, and/or Internet service providers.

The mobile device 102 includes a communication manager 134 that implements features of device resource savings during cellular out-of-service condition, as described herein. The communication manager 134 may be implemented as a module that includes independent processing, memory, and logic components functioning as a computing and/or electronic device integrated with the mobile device 102. Alternatively or in addition, the communication manager 134 can be implemented as a software application or software module, such as computer-executable software instructions that are executable with a processor (e.g., with the processing system 106) of the mobile device 102. As a software application, the communication manager 134 can be stored on computer-readable storage memory (e.g., the device memory 108), or any other suitable memory device or electronic data storage implemented with the communication manager 134.

In aspects of device resource savings during cellular out-of-service condition, the communication manager 134 is implemented to detect an out-of-service condition 136 for lack of a cellular network connection by the cellular radio system 124 with the cellular network 128. The communication manager 134 can also establish the mobile device 102 as the master device in the example system 100, where the master device has master device status over any one or more of the collaborative devices 116, such as the modular component 104 of the mobile device 102, the IoT device 112, and the wearable device 114 that are integrated, synchronized, and/or communicatively linked to the mobile device 102. Notably, the master device status of the mobile device 102 can be established by the communication manager 134 based on the master device having more available battery power than the collaborative devices. For example, a mobile phone may have more available battery power for cellular network scanning than a smaller wearable device or IoT device that is communicatively linked with the mobile phone. Alternatively or in addition, the master device status of the mobile device 102 can be established by the communication manager 134 based on a pre-defined hierarchy of the mobile device in relation to the collaborative devices.

The communication manager 134 can detect the out-of-service condition 136 for lack of the cellular network connection and notify the collaborative device 116 (or multiple collaborative devices) of the master device status by way of a master device notification 138 communicated to the collaborative devices that are integrated, synchronized, and/or communicatively linked to the mobile device 102. This master device notification 138 is effective to initiate the collaborative device 116 saving resources by switching-off the cellular radio system 130 in the collaborative device. In this case, the resources saved may include battery power of the collaborative device power source 122 that would otherwise be utilized to scan for the cellular network 128 during the out-of-service condition, particularly for low power devices (e.g., wearable devices and IoT devices). Notably, if one device (e.g., the mobile device 102) experiences an out-of-service condition for lack of a cellular network connection, then it is very likely that proximate devices (e.g., the collaborative devices 116) will also experience the same out-of-service condition for lack of the connection to the cellular network 128.

Similar to the mobile device 102, the collaborative device 116 may also include a communication manager 140 that implements features of device resource savings during cellular out-of-service condition, as described herein. The communication manager 140 may be implemented as a module that includes independent processing, memory, and logic components functioning as a computing and/or electronic device integrated with the collaborative device 116. Alternatively or in addition, the communication manager 140 can be implemented as a software application or software module, such as computer-executable software instructions that are executable with a processor (e.g., with the processing system 118) of the collaborative device 116. As a software application, the communication manager 140 can be stored on computer-readable storage memory (e.g., the device memory 120), or any other suitable memory device or electronic data storage implemented with the communication manager 140.

The communication manager 140 can also detect the out-of-service condition 142 for lack of the cellular network connection by the cellular radio system 130 with the cellular network 128. The communication manager 140 of the collaborative device 116 can receive the master device notification 138 from the communication manager 134 of the mobile device 102, which indicates that the master device (e.g., the mobile device 102) will perform the scanning 144 for the cellular network 128 during the out-of-service condition. The communication manager 140 can then initiate to switch-off the cellular radio system 130 of the collaborative device 116 for resource savings during the out-of-service condition, such as saving battery power that would otherwise be utilized to scan for the cellular network during the out-of-service condition.

As an alternative to the communication manager 140 of the collaborative device 116 first receiving the master device notification 138 from the communication manager 134 of the mobile device 102 and then initiating to switch-off the cellular radio system 130 of the collaborative device 116, the communication manager 140 of the collaborative device 116 may detect the out-of-service condition 142 for lack of the cellular network connection by the cellular radio system 130 with the cellular network 128, and initiate to switch-off the cellular radio system 130 to conserve device battery power. Given that the master device status of the mobile device 102 may be established based on a pre-defined hierarchy of the mobile device in relation to the collaborative devices, the communication manager 140 of the collaborative device 116 may not wait to receive the master device notification 138 before initiating to switch-off the cellular radio system 130 of the collaborative device 116 during the out-of-service condition 142, thus saving device battery power.

As the designated or pre-defined master device, the cellular radio system 124 of the mobile device 102 can perform the network scanning for all of the devices to detect the cellular network 128 during the out-of-service condition 136, and once determined, can establish the cellular network connection with the cellular network. The communication manager 134 of the mobile device 102 can then communicate scan data 146 associated with detection of the cellular network to the collaborative device 116, where the communication manager 140 of the collaborative device 116 receives the scan data (e.g., as scan data 148). The scan data 146, 148 associated with the detection of the cellular network 128 can include a cellular network identifier 150 of the cellular network 128 and/or a connection power level 152 of the cellular network connection. Generally, the scan data 146, 148 may include various data, such as the absolute radio-frequency channel number (AFRCN) for a Global System for Mobile communications (GSM) cellular system; the EAFRCN (Evolved-UTRA AFRCN) in an LTE network; the type of radio access technology (RAT) for the cellular service (2G/3G/4G/5G technologies); and/or the Public Land Mobile Network (PLMN) Identity of the cellular service. The communication manager 140 can then initiate to switch-on the cellular radio system 130 of the collaborative device 116, which then uses the scan data 148 (e.g., as received from the master device) to establish, or re-establish, a cellular network connection with the cellular network 128.

In alternate aspects of resource savings during cellular out-of-service condition, the communication manager 134 can detect the out-of-service condition 136 for lack of a cellular network connection by the cellular radio system 124 with the cellular network 128, and establish the mobile device 102 as the master device, as described above. The communication manager 134 can then designate different cellular wireless technology generations for the mobile device 102 to scan and for one or more of the collaborative devices 116 to scan. For example, the communication manager 134 can designate a first cellular wireless technology generation (e.g., any of 2G, 3G, 4G, and 5G) for the cellular radio system 124 of the mobile device 102 to scan for the cellular network 128. The communication manager 134 can also designate a second, different cellular wireless technology generation (e.g., any of 2G, 3G, 4G, and 5G) for the cellular radio system 130 of the collaborative device 116 to scan for the cellular network 128. This technique can be effective to determine and connect to a suitable cellular network faster than if just one of the devices is scanning for the cellular network, and can be used to quickly re-establish network connectivity. This is a resource savings during the out-of-service condition 136 in the form of time, and can decrease the duration of time that the devices may be out-of-service.

The communication manager 134 of the mobile device 102 can designate the different cellular wireless technology generation for the collaborative device 116 to scan for the cellular network 128 by way of the master device notification 138 being communicated to the collaborative devices that are integrated, synchronized, and/or communicatively linked to the mobile device 102. This master device notification 138 is effective to initiate the communication manager 140 of the collaborative device 116 to initiate the scan for the cellular network 128 by the cellular radio system 130 of the collaborative device 116. The communication manager 140 of the collaborative device 116 can then communicate the scan data 148 associated with detection of the cellular network 128 back to the mobile device 102. The communication manager 134 of the mobile device 102 can receive the scan data 148 from the collaborative device 116, and combine the scan results (e.g., scan data 146 at the mobile device 102 and scan data 148 from the collaborative device 116) to determine and establish, or re-establish, the cellular network connection with the cellular network 128.

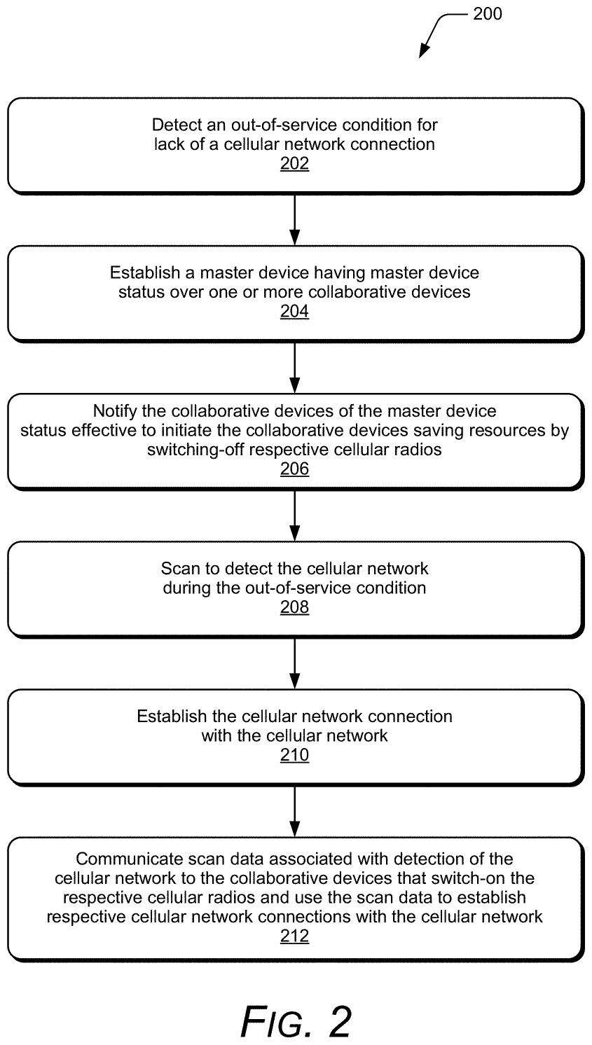

Example methods 200, 300, 400, and 500 are described with reference to respective FIGS. 2-5 in accordance with implementations of device resource savings during cellular out-of-service condition. Generally, any services, components, modules, methods, and/or operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like.

FIG. 2 illustrates example method(s) 200 of device resource savings during cellular out-of-service condition, and is generally described with reference to the communication manager implemented in a master device. The order in which the method is described is not intended to be construed as a limitation, and any number or combination of the described method operations can be performed in any order to perform a method, or an alternate method.

At 202, an out-of-service condition is detected for lack of a cellular network connection. For example, the communication manager 134 implemented by the mobile device 102 detects the out-of-service condition 136 for lack of a cellular connection with the cellular network 128.

At 204, a master device is established as having master device status over one or more collaborative devices. For example, the communication manager 134 establishes the mobile device 102 as the master device in the example system 100 (FIG. 1), where the master device has master device status over any one or more of the collaborative devices 116, such as the modular component 104 of the mobile device 102, the IoT device 112, and the wearable device 114 that are integrated, synchronized, and/or communicatively linked to the mobile device 102. Notably, the master device status of the mobile device 102 can be established by the communication manager 134 based on the master device having more available battery power than the collaborative devices. For example, a mobile phone may have more available battery power for cellular network scanning than a smaller wearable device or IoT device that is communicatively linked with the mobile phone. Alternatively or in addition, the master device status of the mobile device 102 can be established by the communication manager 134 based on a pre-defined hierarchy of the mobile device in relation to the collaborative devices.

At 206, the collaborative devices are notified of the master device status effective to initiate the collaborative devices saving resources by switching-off respective cellular radios. For example, the communication manager 134 of the mobile device 102 notifies the collaborative device 116 (or multiple collaborative devices) of the master device status by way of the master device notification 138 communicated to the collaborative devices that are integrated, synchronized, and/or communicatively linked to the mobile device 102. This master device notification 138 is effective to initiate the collaborative device 116 saving resources by switching-off the cellular radio system 130 in the collaborative device. In this case, the resources saved include battery power of the collaborative device power source 122 that would otherwise be utilized to scan for the cellular network 128 during the out-of-service condition, particularly for low power devices (e.g., wearable devices and IoT devices). Notably, if one device (e.g., the mobile device 102) experiences an out-of-service condition for lack of a cellular network connection, then it is very likely that proximate devices (e.g., the collaborative devices 116) will also experience the same out-of-service condition for lack of the connection to the cellular network 128.

At 208, the cellular network is scanned for and detected during the out-of-service condition, and at 210, the cellular network connection with the cellular network is established. For example, as the designated or pre-defined master device, the cellular radio system 124 of the mobile device 102 is initiated by the communication manager 134 to perform the network scanning for all of the devices to detect the cellular network 128 during the out-of-service condition 136, and once determined, can establish the cellular network connection with the cellular network.

At 212, scan data associated with detection of the cellular network is communicated to the collaborative devices that switch-on the respective cellular radios and use the scan data to establish respective cellular network connections with the cellular network. For example, the communication manager 134 of the mobile device 102 communicates the scan data 146 associated with detection of the cellular network to the collaborative device 116, where the communication manager 140 of the collaborative device 116 receives the scan data (e.g., as the scan data 148). The scan data 146, 148 associated with the detection of the cellular network 128 can include a cellular network identifier 150 of the cellular network 128 and/or a connection power level 152 of the cellular network connection. The communication manager 140 then initiates to switch-on the cellular radio system 130 of the collaborative device 116, which uses the scan data 148 (e.g., as received from the master device) to establish, or re-establish, a cellular network connection with the cellular network 128.

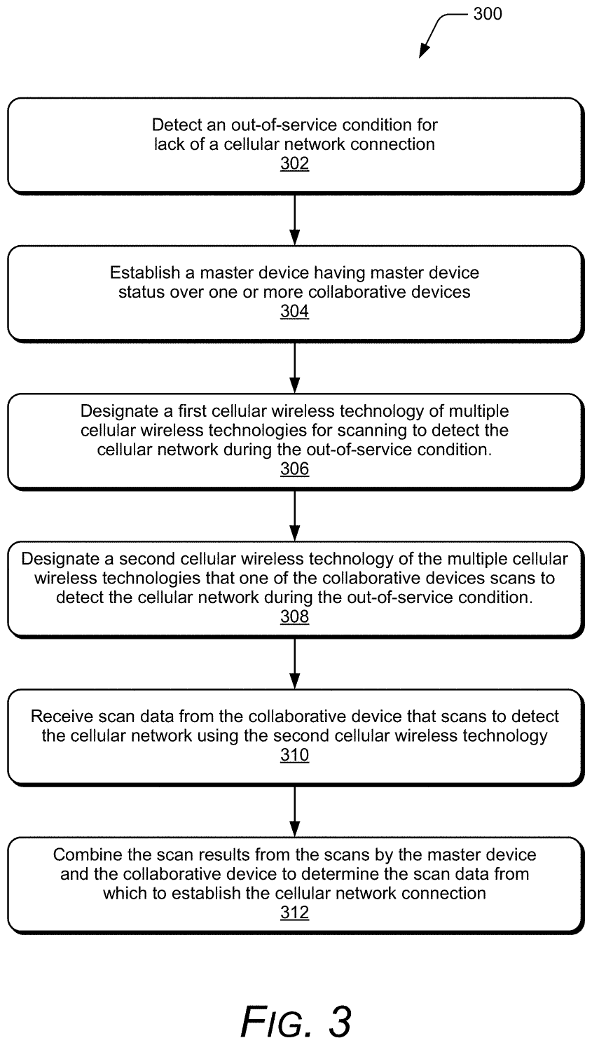

FIG. 3 illustrates example method(s) 300 of device resource savings during cellular out-of-service condition, and is generally described with reference to the communication manager implemented in a master device and scanning distributed across multiple collaborative devices. The order in which the method is described is not intended to be construed as a limitation, and any number or combination of the described method operations can be performed in any order to perform a method, or an alternate method.

At 302, an out-of-service condition is detected for lack of a cellular network connection. For example, the communication manager 134 implemented by the mobile device 102 detects the out-of-service condition 136 for lack of a cellular connection with the cellular network 128.

At 304, a master device is established as having master device status over one or more collaborative devices. For example, the communication manager 134 establishes the mobile device 102 as the master device in the example system 100 (FIG. 1), where the master device has master device status over any one or more of the collaborative devices 116, such as the modular component 104 of the mobile device 102, the IoT device 112, and the wearable device 114 that are integrated, synchronized, and/or communicatively linked to the mobile device 102. Notably, the master device status of the mobile device 102 can be established by the communication manager 134 based on the master device having more available battery power than the collaborative devices. For example, a mobile phone may have more available battery power for cellular network scanning than a smaller wearable device or IoT device that is communicatively linked with the mobile phone. Alternatively or in addition, the master device status of the mobile device 102 can be established by the communication manager 134 based on a pre-defined hierarchy of the mobile device in relation to the collaborative devices.

At 306, a first cellular wireless technology of multiple cellular wireless technologies is designated for scanning to detect the cellular network during the out-of-service condition, and at 308, a second cellular wireless technology of the multiple cellular wireless technologies is designated that one of the collaborative devices scans to detect the cellular network during the out-of-service condition. For example, the communication manager 134 of the mobile device 102 designates different cellular wireless technology generations for the mobile device 102 to scan and for one or more of the collaborative devices 116 to scan. For example, the communication manager 134 designates a first cellular wireless technology generation (e.g., any of 2G, 3G, 4G, and 5G) for the cellular radio system 124 of the mobile device 102 to scan for the cellular network 128. The communication manager 134 also designates a second, different cellular wireless technology generation (e.g., any of 2G, 3G, 4G, and 5G) for the cellular radio system 130 of the collaborative device 116 to scan for the cellular network 128. This technique can be effective to determine and connect to a suitable cellular network faster than if just one of the devices is scanning for the cellular network, and can be used to quickly re-establish network connectivity. This is a resource savings during the out-of-service condition 136 in the form of time, and can decrease the duration of time that the devices may be out-of-service.

At 310, scan data is received from the collaborative device that scans to detect the cellular network using the second cellular wireless technology, and at 312, the scan results from the scans by the master device and the collaborative device are combined to determine the scan data from which to establish the cellular network connection. The communication manager 134 of the mobile device 102 receives the scan data 148 from the collaborative device 116, and combines the scan results (e.g., the scan data 146 at the mobile device 102 and the scan data 148 from the collaborative device 116) to determine and establish, or re-establish, the cellular network connection with the cellular network 128.

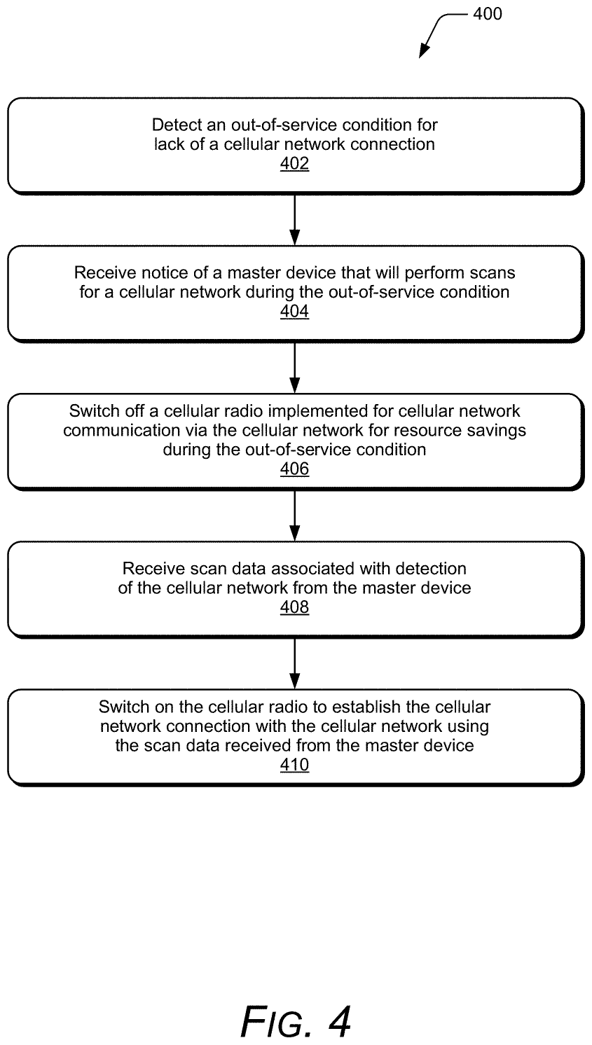

FIG. 4 illustrates example method(s) 400 of device resource savings during cellular out-of-service condition, and is generally described with reference to the communication manager implemented in a collaborative device. The order in which the method is described is not intended to be construed as a limitation, and any number or combination of the described method operations can be performed in any order to perform a method, or an alternate method.

At 402, an out-of-service condition is detected for lack of a cellular network connection. For example, the communication manager 140 implemented by the collaborative device 116 detects the out-of-service condition 142 for lack of a cellular connection with the cellular network 128.

At 404, notice is received of a master device that will perform scans for a cellular network during the out-of-service condition. For example, the communication manager 140 of the collaborative device 116 receives the master device notification 138 from the communication manager 134 of the mobile device 102, which indicates that the master device (e.g., the mobile device 102) will perform the scanning 144 for the cellular network 128 during the out-of-service condition.

At 406, a cellular radio implemented for cellular network communication via the cellular network is switched-off for resource savings during the out-of-service condition. For example, the communication manager 140 of the collaborative device 116 initiates to switch-off the cellular radio system 130 of the collaborative device for resource savings during the out-of-service condition, such as saving battery power that would otherwise be utilized to scan for the cellular network during the out-of-service condition.

At 408, scan data associated with detection of the cellular network is received from the master device, and at 410, the cellular radio is switched-on to establish the cellular network connection with the cellular network using the scan data received from the master device. For example, the communication manager 140 of the collaborative device 116 receives the scan data (e.g., as the scan data 148) from the master device (e.g., the mobile device 102). The scan data 148 associated with the detection of the cellular network 128 can include the cellular network identifier 150 of the cellular network 128 and/or the connection power level 152 of the cellular network connection. The communication manager 140 then initiates to switch-on the cellular radio system 130 of the collaborative device 116, which uses the scan data 148 (e.g., as received from the master device) to establish, or re-establish, a cellular network connection with the cellular network 128.

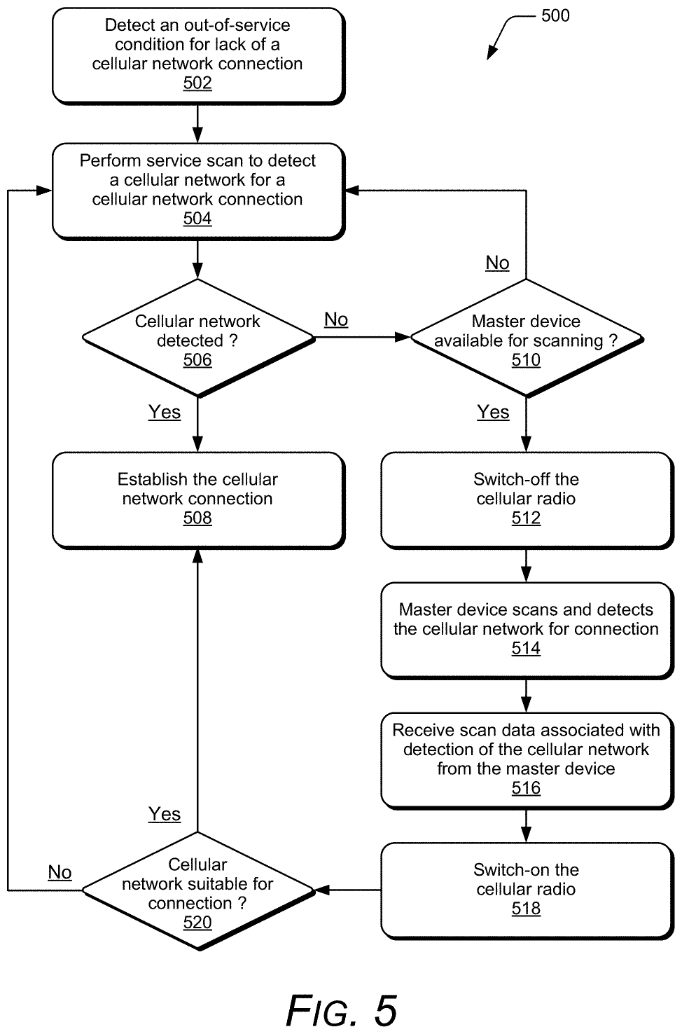

FIG. 5 illustrates example method(s) 500 of device resource savings during cellular out-of-service condition, and is generally described with reference to a communication manager implemented in a master device and/or a communication manager implemented in a collaborative device. The order in which the method is described is not intended to be construed as a limitation, and any number or combination of the described method operations can be performed in any order to perform a method, or an alternate method.

At 502, an out-of-service condition is detected for lack of a cellular network connection. For example, the communication manager 134 implemented by the mobile device 102 detects the out-of-service condition 136 for lack of a cellular connection with the cellular network 128. Similarly, the communication manager 140 implemented by the collaborative device 116 detects the out-of-service condition 142 for lack of a cellular connection with the cellular network 128. Generally, if one device (e.g., the mobile device 102) experiences an out-of-service condition for lack of a cellular network connection, then it is very likely that proximate devices (e.g., the collaborative devices 116) will also experience the same out-of-service condition for lack of the connection to the cellular network 128.

At 504, an initial service scan is performed to detect a cellular network for a cellular network connection. For example, the communication manager 140 of the collaborative device 116 initiates the cellular radio system 130 of the collaborative device 116 to perform an initial service scan to detect the cellular network 128 for a cellular network connection.

At 506, a determination is made as to whether a cellular network has been detected. For example, the communication manager 140 of the collaborative device 116 determines whether the cellular network 128 has been detected. If the cellular network has been detected (i.e., “Yes” from 506), then at 508, the cellular network connection is established. For example, the cellular radio system 130 of the collaborative device 116 establishes the cellular network connection to the cellular network 128 for cellular communication.

If the cellular network is not detected (i.e., “No” from 506), then at 510, a determination is made as to whether a master device is available to perform the scanning for the cellular network. For example, the communication manager 134 of the mobile device 102 may establish the mobile device 102 as the master device in the example system 100 (FIG. 1), where the master device has master device status over any one or more of the collaborative devices 116 that are integrated, synchronized, and/or communicatively linked to the mobile device 102. Notably, the master device status of the mobile device 102 can be established by the communication manager 134 based on the master device having more available battery power than the collaborative devices. For example, a mobile phone may have more available battery power for cellular network scanning than a smaller wearable device or IoT device that is communicatively linked with the mobile phone. Alternatively or in addition, the master device status of the mobile device 102 can be established by the communication manager 134 based on a pre-defined hierarchy of the mobile device in relation to the collaborative devices.

If a master device is not available or established for scanning to detect the cellular network (i.e., “No” from 510), then the collaborative device continues to scan to detect a cellular network for the cellular network connection at 504. If a master device is available or established for scanning to detect the cellular network (i.e., “Yes” from 510), then at 512, the cellular radio of the collaborative device is switched-off. For example, the communication manager 140 of the collaborative device 116 initiates to switch-off the cellular radio system 130 (e.g., a modem and RF unit) of the collaborative device for resource savings during the out-of-service condition, such as saving battery power that would otherwise be utilized to scan for the cellular network during the out-of-service condition.

At 514, the master device scans and detects the cellular network for a cellular network connection. For example, as the designated or pre-defined master device, the cellular radio system 124 of the mobile device 102 is initiated by the communication manager 134 to perform the network scanning for all of the devices to detect the cellular network 128 during the out-of-service condition 136, and once determined, can establish the cellular network connection with the cellular network.

At 516, scan data associated with detection of the cellular network is received from the master device. For example, the communication manager 140 of the collaborative device 116 receives the scan data (e.g., as the scan data 148) from the master device (e.g., the mobile device 102). The scan data 148 associated with the detection of the cellular network 128 can include the cellular network identifier 150 of the cellular network 128 and/or the connection power level 152 of the cellular network connection.

At 518, the cellular radio of the collaborative device is switched-on. For example, the communication manager 140 of the collaborative device 116 then initiates to switch-on the cellular radio system 130 (e.g., the modem and RF unit) of the collaborative device 116, which can then use the scan data 148 (e.g., as received from the master device) to establish, or re-establish, a cellular network connection with the cellular network 128.

At 520, a determination is made as to whether the detected cellular network is suitable for the collaborative device. For example, the communication manager 140 of the collaborative device 116 determines whether the detected cellular network 128 is suitable or compatible for the cellular radio system 130 of the collaborative device 116 to establish the cellular network connection. Generally, the communication manager 140 of the collaborative device 116 can determine whether the collaborative device and the mobile device 102 operate on the same network carrier from the cellular network identifier 150 of the cellular network 128 as received in the scan data 148 from the master device. Alternatively, the communication manager 140 of the collaborative device 116 can determine whether the collaborative device and the mobile device 102 operate on different network carriers from the scan data 148 received from the master device.

If the detected cellular network is not suitable for cellular network connection by the collaborative device (i.e., “No” from 520), then the collaborative device continues to scan to detect a cellular network for the cellular network connection at 504. If the detected cellular network is suitable for cellular network connection by the collaborative device (i.e., “Yes” from 520), then the cellular network connection is established at 508. For example, the cellular radio system 130 of the collaborative device 116 establishes the cellular network connection to the cellular network 128 for cellular communication.

FIG. 6 illustrates various components of an example device 600, in which aspects of device resource savings during cellular out-of-service condition can be implemented. The example device 600 can be implemented as any of the devices described with reference to the previous FIGS. 1-5, such as any type of a device, mobile device, collaborative device, access point, node device, IoT device, mobile phone, client device, wearable device, tablet, computing, communication, entertainment, gaming, media playback, and/or other type of electronic device. For example, the mobile device 102 and the collaborative device 116 shown and described with reference to FIG. 1 may be implemented as the example device 600. Further a wearable device may include any one or combination of a watch, armband, wristband, bracelet, glove or pair of gloves, glasses, jewelry items, clothing items, any type of footwear or headwear, and/or other types of wearables.

The device 600 includes communication transceivers 602 that enable wired and/or wireless communication of device data 604 with other devices. The device data 604 can include any of the communication manager generated and/or determined data. Additionally, the device data 604 can include any type of audio, video, and/or image data. Example communication transceivers 602 include wireless personal area network (WPAN) radios compliant with various IEEE 802.15 (Bluetooth™) standards, wireless local area network (WLAN) radios compliant with any of the various IEEE 802.11 (WiFi™) standards, wireless wide area network (WWAN) radios for cellular phone communication, wireless metropolitan area network (WMAN) radios compliant with various IEEE 802.16 (WiMAX™) standards, and wired local area network (LAN) Ethernet transceivers for network data communication.

The device 600 may also include one or more data input ports 606 via which any type of data, media content, and/or inputs can be received, such as user-selectable inputs to the device, messages, music, television content, recorded content, and any other type of audio, video, and/or image data received from any content and/or data source. The data input ports may include USB ports, coaxial cable ports, and other serial or parallel connectors (including internal connectors) for flash memory, DVDs, CDs, and the like. These data input ports may be used to couple the device to any type of components, peripherals, or accessories such as microphones and/or cameras.

The device 600 includes a processor system 608 of one or more processors (e.g., any of microprocessors, controllers, and the like) and/or a processor and memory system implemented as a system-on-chip (SoC) that processes computer-executable instructions. The processor system may be implemented at least partially in hardware, which can include components of an integrated circuit or on-chip system, an application-specific integrated circuit (ASIC), a field-programmable gate array (FPGA), a complex programmable logic device (CPLD), and other implementations in silicon and/or other hardware. Alternatively or in addition, the device can be implemented with any one or combination of software, hardware, firmware, or fixed logic circuitry that is implemented in connection with processing and control circuits, which are generally identified at 610. The device 600 may further include any type of a system bus or other data and command transfer system that couples the various components within the device. A system bus can include any one or combination of different bus structures and architectures, as well as control and data lines.

The device 600 also includes computer-readable storage memory 612 (e.g., memory devices) that enable data storage, such as data storage devices that can be accessed by a computing device, and that provide persistent storage of data and executable instructions (e.g., software applications, programs, functions, and the like). Examples of the computer-readable storage memory 612 include volatile memory and non-volatile memory, fixed and removable media devices, and any suitable memory device or electronic data storage that maintains data for computing device access. The computer-readable storage memory can include various implementations of random access memory (RAM), read-only memory (ROM), flash memory, and other types of storage media in various memory device configurations. The device 600 may also include a mass storage media device.

The computer-readable storage memory 612 provides data storage mechanisms to store the device data 604, other types of information and/or data, and various device applications 614 (e.g., software applications). For example, an operating system 616 can be maintained as software instructions with a memory device and executed by the processor system 608. The device applications may also include a device manager 618, such as any form of a control application, software application, signal-processing and control module, code that is native to a particular device, a hardware abstraction layer for a particular device, and so on.

In this example, the device 600 includes a communication manager 620 that implements aspects of device resource savings during cellular out-of-service condition. The communication manager 620 may be implemented with hardware components and/or in software as one of the device applications 614, such as when the device 600 is implemented as the mobile device 102 and/or as any one of the collaborative devices 116 described with reference to FIG. 1. Examples of the communication manager 620 include the communication manager 134 that is implemented as a software application and/or as hardware components in the mobile device 102, and the communication manager 140 that is implemented as a software application and/or as hardware components in the collaborative device 116. In implementations, the communication manager 620 may include independent processing, memory, and logic components as a computing and/or electronic device integrated with the example device 600.

In this example, the device 600 also includes a camera 622 and motion sensors 624, such as may be implemented as components of an inertial measurement unit (IMU). The motion sensors 624 can be implemented with various sensors, such as a gyroscope, an accelerometer, and/or other types of motion sensors to sense motion of the device. The motion sensors 624 can generate sensor data vectors having three-dimensional parameters (e.g., rotational vectors in x, y, and z coordinates) indicating position, location, and/or orientation of the device. The device 600 can also include one or more power sources 626, such as when the device is implemented as a mobile device or collaborative device. The power sources may include a charging and/or power system, and can be implemented as a flexible strip battery, a rechargeable battery, a charged super-capacitor, and/or any other type of active or passive power source.

The device 600 can also include an audio and/or video processing system 628 that generates audio data for an audio system 630 and/or generates display data for a display system 632. The audio system and/or the display system may include any devices that process, display, and/or otherwise render audio, video, display, and/or image data. Display data and audio signals can be communicated to an audio component and/or to a display component via an RF (radio frequency) link, S-video link, HDMI (high-definition multimedia interface), composite video link, component video link, DVI (digital video interface), analog audio connection, or other similar communication link, such as media data port 634. In implementations, the audio system and/or the display system are integrated components of the example device. Alternatively, the audio system and/or the display system are external, peripheral components to the example device.

Although implementations of device resource savings during cellular out-of-service condition have been described in language specific to features and/or methods, the subject of the appended claims is not necessarily limited to the specific features or methods described. Rather, the specific features and methods are disclosed as example implementations of device resource savings during cellular out-of-service condition, and other equivalent features and methods are intended to be within the scope of the appended claims. Further, various different examples are described and it is to be appreciated that each described example can be implemented independently or in connection with one or more other described examples. Additional aspects of the techniques, features, and/or methods discussed herein relate to one or more of the following:

A device, comprising: a cellular radio for cellular network communication via a cellular network; a communication manager implemented at least partially in hardware to: detect an out-of-service condition for lack of a cellular network connection; communicate a notification to one or more collaborative devices that the device is a master device configured to scan for the cellular network during the out-of-service condition, the notification effective to initiate the one or more collaborative devices saving resources by switching-off respective cellular radios; initiate scans to detect the cellular network and establish the cellular network connection with the cellular network; and communicate scan data associated with detection of the cellular network to the one or more collaborative devices that use the scan data to establish respective cellular network connections with the cellular network.

Alternatively or in addition to the above described device, any one or combination of: the scan data associated with the detection of the cellular network includes at least one of an identifier of the cellular network and a power level of the cellular network connection. The communication manager is implemented to establish the device as the master device based on the device having more available battery power than the one or more collaborative devices. The communication manager is implemented to establish the device as the master device based on a pre-defined hierarchy of the device in relation to the one or more collaborative devices. The cellular network connection is via one of multiple cellular wireless technologies; and the communication manager is implemented to designate a first cellular wireless technology that the device scans to detect the cellular network and establish the cellular network connection, and designate at least a second cellular wireless technology that one of the collaborative devices scans to detect the cellular network from which to establish a respective cellular network connection. The multiple cellular wireless technologies include 2G, 3G, 4G, and 5G generations of the multiple cellular wireless technologies. The communication manager is implemented to combine scan results from the scans by the device and the one or more collaborative devices to determine the scan data from which to establish the cellular network connection.

A method, comprising: detecting an out-of-service condition for lack of a cellular network connection; notifying one or more collaborative devices of master device status effective to initiate the one or more collaborative devices saving resources by switching-off respective cellular radios; scanning to detect the cellular network during the out-of-service condition; establishing the cellular network connection with the cellular network; and communicating scan data associated with detection of the cellular network to the one or more collaborative devices that switch-on the respective cellular radios and use the scan data to establish respective cellular network connections with the cellular network.

Alternatively or in addition to the above described method, any one or combination of: the scan data associated with the detection of the cellular network includes at least one of an identifier of the cellular network and a power level of the cellular network connection. The method includes establishing a master device having the master device status based on the master device having more available battery power than the one or more collaborative devices. The method includes establishing a master device having the master device status based on a pre-defined hierarchy of the master device in relation to the one or more collaborative devices. The method includes designating a first cellular wireless technology of multiple cellular wireless technologies for said scanning to detect the cellular network during the out-of-service condition; and designating at least a second cellular wireless technology of the multiple cellular wireless technologies that one of the collaborative devices scans to detect the cellular network during the out-of-service condition. The multiple cellular wireless technologies include 2G, 3G, 4G, and 5G generations of the multiple cellular wireless technologies. The method includes combining scan results from the scans by a master device and the one or more collaborative devices to determine the scan data from which to establish the cellular network connection.

A device, comprising: a cellular radio for cellular network communication via a cellular network; a communication manager implemented at least partially in hardware to: detect an out-of-service condition for lack of a cellular network connection; receive notice of a master device that will perform scans for the cellular network during the out-of-service condition; switch-off the cellular radio in the device for resource savings during the out-of-service condition; receive scan data associated with detection of the cellular network from the master device; and switch-on the cellular radio to establish the cellular network connection with the cellular network using the scan data received from the master device.

Alternatively or in addition to the above described device, any one or combination of: the scan data associated with the detection of the cellular network includes at least one of an identifier of the cellular network and a power level of the cellular network connection with the master device. The communication manager is implemented to establish the device as a collaborative device based on the device having less available battery power than the master device. The communication manager is implemented to establish the device as a collaborative device based on a pre-defined hierarchy of the device in relation to the master device. The cellular network connection is via one of multiple cellular wireless technologies that include 2G, 3G, 4G, and 5G generations of the multiple cellular wireless technologies.

A method, comprising: detecting an out-of-service condition for lack of a cellular network connection; receiving notice of a master device that will perform scans for a cellular network during the out-of-service condition; switching-off a cellular radio implemented for cellular network communication via the cellular network for resource savings during the out-of-service condition; receiving scan data associated with detection of the cellular network from the master device; and switching-on the cellular radio to establish the cellular network connection with the cellular network using the scan data received from the master device.

1. A device, comprising:
a cellular radio for cellular network communication via a cellular network;
a communication manager implemented at least partially in hardware to:
detect an out-of-service condition for lack of a cellular network connection;
communicate a notification to one or more collaborative devices that the device is a master device configured to scan for the cellular network during the out-of-service condition, the notification effective to initiate the one or more collaborative devices saving resources by switching-off respective cellular radios;
initiate scans to detect the cellular network and establish the cellular network connection with the cellular network; and
communicate scan data associated with detection of the cellular network to the one or more collaborative devices that use the scan data to establish respective cellular network connections with the cellular network.

2. The device as recited in claim 1, wherein the scan data associated with the detection of the cellular network includes at least one of an identifier of the cellular network and a power level of the cellular network connection.

3. The device as recited in claim 1, wherein the communication manager is implemented to establish the device as the master device based on the device having more available battery power than the one or more collaborative devices.

4. The device as recited in claim 1, wherein the communication manager is implemented to establish the device as the master device based on a pre-defined hierarchy of the device in relation to the one or more collaborative devices.

5. The device as recited in claim 1, wherein:
the cellular network connection is via one of multiple cellular wireless technologies; and
the communication manager is implemented to designate a first cellular wireless technology that the device scans to detect the cellular network and establish the cellular network connection, and designate at least a second cellular wireless technology that one of the collaborative devices scans to detect the cellular network from which to establish a respective cellular network connection.

6. The device as recited in claim 5, wherein the multiple cellular wireless technologies include 2G, 3G, 4G, and 5G generations of the multiple cellular wireless technologies.

7. The device as recited in claim 5, wherein the communication manager is implemented to combine scan results from the scans by the device and the one or more collaborative devices to determine the scan data from which to establish the cellular network connection.

8. A method, comprising:
detecting an out-of-service condition for lack of a cellular network connection;
notifying one or more collaborative devices of master device status effective to initiate the one or more collaborative devices saving resources by switching-off respective cellular radios;
scanning to detect the cellular network during the out-of-service condition;
establishing the cellular network connection with the cellular network; and
communicating scan data associated with detection of the cellular network to the one or more collaborative devices that switch-on the respective cellular radios and use the scan data to establish respective cellular network connections with the cellular network.

9. The method as recited in claim 8, wherein the scan data associated with the detection of the cellular network includes at least one of an identifier of the cellular network and a power level of the cellular network connection.

10. The method as recited in claim 8, further comprising:
establishing a master device having the master device status based on the master device having more available battery power than the one or more collaborative devices.

11. The method as recited in claim 8, further comprising:
establishing a master device having the master device status based on a pre-defined hierarchy of the master device in relation to the one or more collaborative devices.

12. The method as recited in claim 8, further comprising:
designating a first cellular wireless technology of multiple cellular wireless technologies for said scanning to detect the cellular network during the out-of-service condition; and
designating at least a second cellular wireless technology of the multiple cellular wireless technologies that one of the collaborative devices scans to detect the cellular network during the out-of-service condition.

13. The method as recited in claim 12, wherein the multiple cellular wireless technologies include 2G, 3G, 4G, and 5G generations of the multiple cellular wireless technologies.

14. The method as recited in claim 12, further comprising:
combining scan results from the scans by a master device and the one or more collaborative devices to determine the scan data from which to establish the cellular network connection.

15. A device, comprising:
a cellular radio for cellular network communication via a cellular network;
a communication manager implemented at least partially in hardware to:
detect an out-of-service condition for lack of a cellular network connection;
receive notice of a master device that will perform scans for the cellular network during the out-of-service condition;
switch-off the cellular radio in the device for resource savings during the out-of-service condition;
receive scan data associated with detection of the cellular network from the master device; and
switch-on the cellular radio to establish the cellular network connection with the cellular network using the scan data received from the master device.

16. The device as recited in claim 15, wherein the scan data associated with the detection of the cellular network includes at least one of an identifier of the cellular network and a power level of the cellular network connection with the master device.

17. The device as recited in claim 15, wherein the communication manager is implemented to establish the device as a collaborative device based on the device having less available battery power than the master device.

18. The device as recited in claim 15, wherein the communication manager is implemented to establish the device as a collaborative device based on a pre-defined hierarchy of the device in relation to the master device.

19. The device as recited in claim 15, wherein the cellular network connection is via one of multiple cellular wireless technologies that include 2G, 3G, 4G, and 5G generations of the multiple cellular wireless technologies.

20. A method, comprising:
detecting an out-of-service condition for lack of a cellular network connection;
receiving notice of a master device that will perform scans for a cellular network during the out-of-service condition;
switching-off a cellular radio implemented for cellular network communication via the cellular network for resource savings during the out-of-service condition;
receiving scan data associated with detection of the cellular network from the master device; and
switching-on the cellular radio to establish the cellular network connection with the cellular network using the scan data received from the master device.
